(19) United States
(12) Patent Application Publication
(10) Pub. No.: US 2022/0023677 A1
(43) Pub. Date: Jan. 27, 2022

(54) POWERED AIR PURIFYING RESPIRATOR

(71) Applicants: Samuel Chen, Causeway Bay (HK); Kurt Groen, Coraopolis, PA (US)

(72) Inventors: Samuel Chen, Causeway Bay (HK); Kurt Groen, Coraopolis, PA (US)

(21) Appl. No.: 16/934,496

(22) Filed: Jul. 21, 2020

(51) Int. Cl. A62B 18/04

(52) U.S. Cl. CPC A62B 18/045

(57) ABSTRACT

A powered air purifying respirator has a headcover with an air intake, a face cover, and a neck cover. The face cover seals to the headcover and pivots from the headcover. The neck cover extends from the headcover and the face cover. A first fan motor powers a first fan and a second fan motor powers a second fan. The headcover has an upper section and a lower section. The first fan is flow connected to the upper section. The upper section is formed as a hollow area between a user's head and the headcover. The first fan is flow connected to the lower section. The lower section is formed as a hollow area between a user's face and the face cover. A filter draws air from outside of the upper section and lower section. The filter is driven by a fan.

### FIELD OF THE INVENTION

The present invention is in the field of powered air purifying respirators.

### DISCUSSION OF RELATED ART

A variety of prior art references describe various structures for powered air purifying respirators. For example, in the International patent number AU2011227672 A Powered Air Purifying Respirator by inventor Desmond T. Curran et al., published Sep. 22, 2011 the abstract discloses, “A powered air purifying respirator (PAPR) for delivering a forced flow of filtered air to a wearer is disclosed. The PAPR comprises a turbo unit with turbo unit components including a fan, an electric motor, and an electronic control unit having a wireless electronic control transceiver, the fan being driven by the electric motor under the control of the electronic control unit and the electronic control unit being configured to send and receive information via the electronic control transceiver; a turbo unit power source that provides power to the turbo unit components; a turbo remote control unit having a wireless turbo remote control transceiver; at least one turbo status indicator unit, adapted to indicate a current operating status of the turbo unit and/or turbo unit components, having a wireless turbo status transceiver; wherein at least one of the turbo remote control unit and turbo status indicator unit is remote from the turbo unit, and wherein at least two of the electronic control transceiver, the turbo remote control transceiver and the turbo status transceiver are in wireless communication with each other.”

Also for example, in the International patent number RU2566910 Full Face Mask For Electrically Driven Air-Purifying Respirator (PAPR)) by inventor Oliver KLOKSET, published Oct. 27, 2015 the abstract discloses, “FIELD: fire safety. SUBSTANCE: full face mask for electrically driven air-purifying respirator (PAPR), which must be used in unhealthy environments. The mask has an air inlet and an air outlet. According to the invention, it is made as a single piece from a transparent plastic material in a process of a single stage vacuum moulding with the field of view unfolded on a plane, free from distortions, and in that it comprises a compartment inside the full face mask to accommodate the blower unit, and the said compartment is located in the area of the front part of the full face mask and open into the inner space of the full face mask. EFFECT: improved design. 19 cl, 7 dwg.”

Also for example, in U.S. Pat. No. 3,822,698 Powered Air-Purifying Respirator Helmet by inventor R Guy, published Jul. 9, 1974 the abstract discloses, “A helmet or hat equipped with a built-in powered air blower and air filtering system which removes contaminants from the surrounding air and continuously delivers the purified air under positive pressure to an area between the wearers face and a fitted transparent face shield supported from the visor, and from this area the wearer breathes normally while the excess filtered air and exhaled breath escapes through a slightly restricted opening between the bottom of the mask and the wearer's chin.”

Also for example, in U.S. Pat. No. 4,590,951 Breathing Apparatus by inventor Richard K. O'Connor, published May 27, 1986 the abstract discloses, “A power assisted respirator comprises a facepiece for covering at least the nose and mouth of the wearer which has an outlet provided with a one-way exhale valve which is openable to permit air to flow out of the facepiece when a predetermined pressure P is established within the facepiece. A pump unit supplies air to the space within the facepiece. The pump unit may be connected to an inlet of the facepiece by a flexible hose or may be mounted directly on or in the facepiece. A filter canister is connected to the inlet of the pump means for filtering air supplied to the facepiece. A one-way inlet valve is provided in the path of air flowing from the pump unit to the facepiece and a pressure sensor is provided for sensing the pressure of air in the region of the pump unit inlet for causing deenergisation of the pump unit when the pressure in the region of the pump unit inlet exceeds a predetermined level. The operating parameters of the pump of the pump unit and the exhale valve are selected so that the pressure within the facepiece at which the exhale valve will open slightly exceeds the pressure at the outlet of the pump which will cause the pump to cease or substantially cease operating effectively.”

Also for example, in U.S. Pat. No. 6,772,762 Personal Powered Air Filtration, Sterilization, And Conditioning System by inventor Gregory Hubert Piesinger, published Aug. 10, 2004 the abstract discloses, “Hollow eyeglass frames are combined with a wearable distributed air pump to form a portable positive pressure powered air purifying delivery system for inconspicuously supplying respirable air to the nostrils of an individual. Ambient air is pressurized by combining the outputs of a plurality of piston compression tubes arranged and connected to form a thin flexible pump that can be worn around the waist. This pressurized air is passed through filter and conditioning modules to form respirable air, which is then piped to air inlet ports on the hollow frame eyeglass temples using small diameter tubing. Nose tubes on the hollow eyeglass frames near the nose inconspicuously direct the respirable air into the nostrils at a rate that exceeds the peak inhalation rate of the individual, thereby preventing the inhalation of unfiltered air.”

Also for example, in U.S. Pat. No. 6,957,653 Flushed-seal respirator by inventor Donald L. Campbell et al., published Oct. 25, 2005 the abstract discloses, “Improved full-face, flushed-seal respirators are provided having a primary sealing element adjacent to a breathing space and a secondary sealing element. Exhaled air (i.e., clean air obtained by passage through a filtering element or elements) is passed from the breathing space into a flushing channel formed between the primary and secondary seals. If there is leakage in the primary seal, air from this flushing channel leaks into the breathing space rather than ambient air. Air within the flushing channel will predominately be air that has already passed through the filtering elements. The present invention provides, therefore, an inexpensive respirator which is provides significantly more protection than conventional negative-pressure respirators.”

Also for example, in U.S. Pat. No. 7,832,396 High Air Flow Powered Air Purifying Anti-Contamination Device by inventor Alfred Campbell Abernethy, published Nov. 16, 2010 the abstract discloses, “A high output, powered air purifying respirator that includes an anti-contamination suit, a filter for filtering particulates from the air, a high powered blower for delivering a cool flow of air to the body, and a stabilization mechanism. The stabilization mechanism is configurable in either head mounted or back mounted modules as desired by a worker. The head mounted configuration facilitates stream lined mobility and includes a head mounted suspension system with a circular rail and roller bearing halo around the worker's head for stabilizing the blower/filter and allowing for rotation of the worker's head inside the halo. The invention also includes additional modules, also configurable by the user, such as personal hydration and independent camera and dosimeter support.”

Also for example, in U.S. Pat. No. 8,069,853 Breath responsive powered air-purifying respirator by inventor Greg A. Tilley, Dec. 6, 2011 the abstract discloses, “A system for regulating the airflow to a closed environment using feedback control for the position of a control valve and blower speed. The system provides a control apparatus that regulates airflow to a closed environment, such as the mask of a breathing apparatus, to ensure sufficient breathing air for a wearer of such mask. In order to provide fast response to a change in condition in the breathable environment, the airflow regulator includes a valve control and a blower control.”

Also for example, in U.S. Pat. No. 8,667,959 Modular Powered Air Purifying Respirator by inventor Greg A. Tilley et al., published Mar. 11, 2014 the abstract discloses, “A modular powered air purifying respirator (PAPR) which is comprised of a fan, motor, scroll, and power source mounted within one housing, and which accepts either traditional or conformal filters. Ambient air is drawn into the PAPR module through the attached filter by a fan, which is driven by direct connection to a motor. The pressurized air is then accelerated by an optimized scroll to the outlet in the PAPR housing. The PAPR module can be employed in multiple use configurations. The PAPR module further comprises a removable battery pack module that is easily retained to/removed from the PAPR module, enabling a user to be able to quickly remove a spent battery pack module and install a fresh battery pack module, thereby replacing the batteries within one breath cycle.”

Also for example, in U.S. Pat. No. 3,822,698 Powered Air-Purifying Respirator Helmet by inventor R Guy, published Jul. 9, 1974 the abstract discloses, “A helmet or hat equipped with a built-in powered air blower and air filtering system which removes contaminants from the surrounding air and continuously delivers the purified air under positive pressure to an area between the wearers face and a fitted transparent face shield supported from the visor, and from this area the wearer breathes normally while the excess filtered air and exhaled breath escapes through a slightly restricted opening between the bottom of the mask and the wearers chin.”

Also for example, in U.S. Pat. No. 8,887,719 Air Filtration Device Having Tuned Air Distribution System by inventor Britton Ci. Billingsley et al., published Nov. 18, 2014 the abstract discloses, “A filtering device 10 that includes a housing 12 having a plurality of subsections 32, 34, and 36 where each subsection is adapted to receive a filter element 26, 28, and 30. An inlet 18 is disposed at a first location on the housing 12, and an upstream air distribution system is placed in fluid communication with the inlet 18 and with each of the subsections 32, 34, and 36. A downstream air distribution system is located in fluid communication with each subsection 32, 34, and 36, and an outlet 20 in fluid communication with the downstream air distribution system. The upstream and downstream air distribution systems are constructed to cause the same airflow velocity through each subsection. Using such a construction, overall product service life may be increased while minimizing pressure resistance of the total filter.”

Also for example, in U.S. Pat. No. 8,936,022 Air delivery apparatus for respirator hood by inventor Garry J. Walker, published Jan. 20, 2015 the abstract discloses, “A respirator assembly has a respirator hood having a front side that includes a visor and a back side that includes an air inlet opening. The respirator assembly also has a shape stable manifold having an air inlet conduit extending through the air inlet opening of the hood and having, within the hood, a plurality of air delivery conduits in fluid communication with the air inlet conduit.”

Also for example, in U.S. Pat. No. 9,358,409 Air Filtration Device by inventor David L. Ausen, published Jun. 7, 2016 the abstract discloses, “Air filtering devices may be helmet-mounted or belt-mounted. The air filtering devices include a filtering device shell and a filtering unit. The filtering unit includes a contaminated-air inlet, a filter assembly in fluid communication with the contaminated-air inlet, a blower assembly in fluid communication with the filter assembly via a duct, and containing a filtered-air outlet, and a filtered-air passageway in fluid communication with the blower assembly outlet and leading to breathing headgear. The blower assembly is vibrationally isolated from the filtering device shell by being only attached to the filtering device shell by the duct. The duct includes an elastomeric material.”

Also for example, in United. States patent number 10,441,828 Powered Air-Purifying Respirator by inventor Desmond T. Curran et al., published Oct. 15, 2019 the abstract discloses, “A powered air purifying respirator (PAPR) for delivering a forced flow of filtered air to a wearer is disclosed. The PAPR comprises a turbo unit with turbo unit components including a fan, an electric motor, and an electronic control unit having a wireless electronic control transceiver, the fan being driven by the electric motor under the control of the electronic control unit and the electronic control unit being configured to send and receive information via the electronic control transceiver; a turbo unit power source that provides power to the turbo unit components; a turbo remote control unit having a wireless turbo remote control transceiver; at least one turbo status indicator unit, adapted to indicate a current operating status of the turbo unit and/or turbo unit components, having a wireless turbo status transceiver; wherein at least one of the turbo remote control unit and turbo status indicator unit is remote from the turbo unit, and wherein at least two of the electronic control transceiver, the turbo remote control transceiver and the turbo status transceiver are in wireless communication with each other.”

Also for example, in United States publication number 20060177356A1 Positive Pressure Air Purification And Conditioning System by inventor Gregory Miller, published Aug. 10, 2006 the abstract discloses, “An air purification system utilizing an ultraviolet germicidal lamp is disclosed. The air purification system is in fluid communication with a ventilation duct. The air purification system may also be in fluid communication with the ambient air. The air purification system may incorporate an actuator for the selection of the ambient air, the ventilation duct, or both as an air source for treatment. The air purification system may also be used to obtain a positive pressure within an enclosed space.”

Also for example, in United States publication number 20090314295A1 Powered Air Purifying Respirator by inventor Tom Hatmaker, published Dec. 24, 2009 the abstract discloses, “A powered air purifying respirator includes a housing defining an air inlet and an air outlet; a filter assembly operably connected to the housing for removing contaminants from air passing there through; an impeller/motor assembly contained within the housing for drawing air through the air inlet and through the filter; a flow sensor contained within the housing for measuring air flow from the air inlet to the air outlet; and a liner contained within the housing for locating and retaining the various internal components, while also aiding in attenuating a force of impact to the housing, the liner further defining an air pathway from the impeller/motor assembly through the flow sensor and to the air outlet.” The above prior art references are incorporated herein by reference.

### SUMMARY OF THE INVENTION

A powered air purifying respirator has a headcover with an air intake, a face cover, and a neck cover. The face cover seals to the headcover and pivots from the headcover. The neck cover extends from the headcover and the face cover. A first fan motor powers a first fan and a second fan motor powers a second fan. The headcover has an upper section and a lower section. The first fan is flow connected to the upper section. The upper section is formed as a hollow area between a user's head and the headcover. The first fan is flow connected to the lower section. The lower section is formed as a hollow area between a user's face and the face cover. A filter draws air from outside of the upper section and lower section. The filter is driven by a fan.

The first or second fan can be connected to the lower section to allow improved user respiration. A face filter can be mounted on the face cover to filter incoming air. An ear filter can be mounted on the headcover to filter incoming air and improve audio. A headband separates the upper section from the lower section. Preferably, the headcover is made of a soft foam shell. The neck wrap preferably has a comfortable neck cushion.

A heatpipe mounted within the headcover is configured for exhaustion heat from the upper section and can be combined with a Peltier thermoelectric cooler element, A brim extends outwardly and may have a light and a power switch. Internal airflow channels can be formed on the upper section so that the airflow channels direct air from a front of a user's head to a rear of a user's head. A rear cushion is preferably mounted on the headcover. The headcover may have a neck adapter that connects to the face cover at a face adapter connection. The face adapter connection is formed as a releasable gasket. The neck adapter has a neck cover connection.

The upper section has an upper airflow across a users head, and wherein the lower section retains a lower airflow across a user's face. A second fan powered by a second fan motor can assist the first fan to allow the upper section and the lower section to have different modes of operation. The first fan motor and the second fan motor are reversible so that the upper section can be drawing air while the lower section is exhausting air. Similarly, the lower section can be drawing air while the upper section is exhausting air.

The first fan motor is connected to a first bidirectional H bridge control circuit and the second fan motor is connected to a second bidirectional H bridge control circuit. A controller controls the first bidirectional H bridge control circuit and the second bidirectional bridge control circuit. A display can be mounted to the headcover for displaying a visual indicator of an operating status of the powered air purifying respirator. The display is connected to the controller.

### BRIEF DESCRIPTION OF THE DRAWINGS

FIG. 1 is a perspective view of the present invention

FIG. 2 is a front view of the present invention

FIG. 3 is a side cross-section view of the present invention

FIG. 4 a perspective view of the present invention

FIG. 5 is a circuit diagram showing the motor control and display circuit.

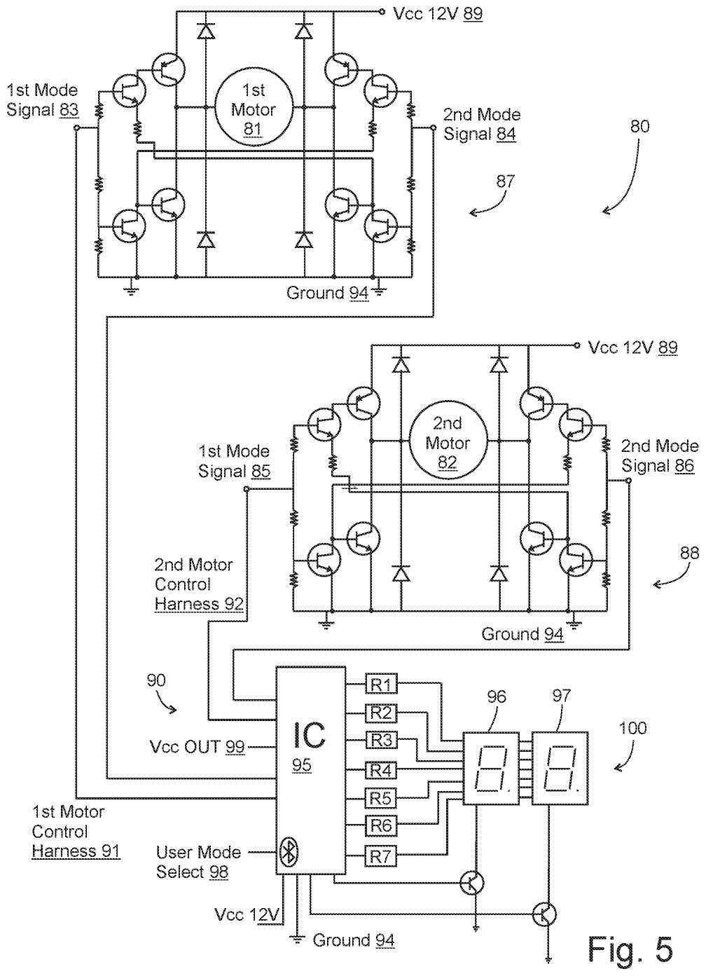

The following callout list of elements can be a useful guide in referencing the element numbers of the drawings.
20 headcover
21 brim
22 battery housing
23 adjusting buckle
24 internal airflow channel
25 air intake
26 air intake openings
27 light
28 flip up cover hinge
29 power button
30 face cover
31 upper airflow
32 lower airflow
33 fabric cover
34 rear cushion
35 hook and loop flap connector
36 fan
37 face cover hinge
38 neck cushion
40 neck cover
41 neck adapter
42 neck adapter connection
43 face cover connection
44 power cable
45 power plug
46 electrical connector
47 neck wrap
50 soft foam shell
51 first exhaust fan
52 second exhaust fan
53 thermoelectric cooler
54 heat pipe
55 first airflow exhaust
56 second airflow exhaust
57 headband
58 ear opening
59 ear filter
71 upper section
72 lower section
73 heat exchanger
74 external battery
80 fan motor assembly
81 first fan motor
82 second fan motor
83 first motor first mode signal
84 first motor second mode signal
85 second motor first mode signal
86 second motor second mode signal
87 first bidirectional H bridge control circuit
88 second bidirectional H bridge control circuit
89 12V power supply line
90 control module
91 first motor control harness
92 second motor control harness
94 ground
95 controller
96 first 7 segment display
97 second 7 segment display
98 user mode select
99 power output control
100 display

### DETAILED DESCRIPTION OF THE PREFERRED EMBODIMENT

### Glossary:

IC is an integrated circuit

DC refers to direct current

Vcc refers to a power input

H Bridge refers to a reversible power circuit that can be drawn in the shape of an H

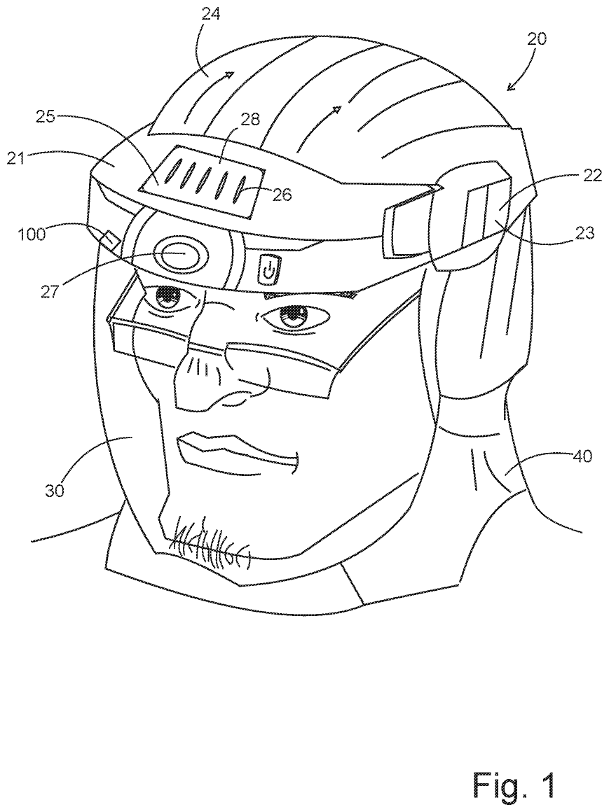

As seen in FIG. 1, the headcover 20 can be formed as a helmet or hat shaped structure with a brim 21. A battery housing having a battery 22 can be formed on the headcover 20. The headcover 20 can be formed as a housing for enclosing interior internal airflow channels 24. The internal airflow channels 24 preferably pass from a front portion of the headcover 20 to a rear portion of the headcover 20. The headcover 20 also has an adjusting buckle 23 to provide a tightening of the headcover 20.

The brim 21 may have their intake openings 26 on an air intake 25 to allow a flow of air to enter and pass through a filter before continuing to the internal airflow channel 24. The brim 21 they also have a light 27 that is operatively connected to the battery housing 22. A neck cover 40 hangs from the headcover 20, and a face cover 30 connects to the next cover 40 and is connected to the headcover 20. The headcover 20 can have a swivel connection such as a flip up cover hinge 28 to allow the face cover 30 to be swiveled and adjusted. Preferably, a display 100 provides a visual indicator for determining operation. The fan is mounted behind the air intake openings 26 and powered by a battery housing 22 that can also be mounted in the headcover 20.

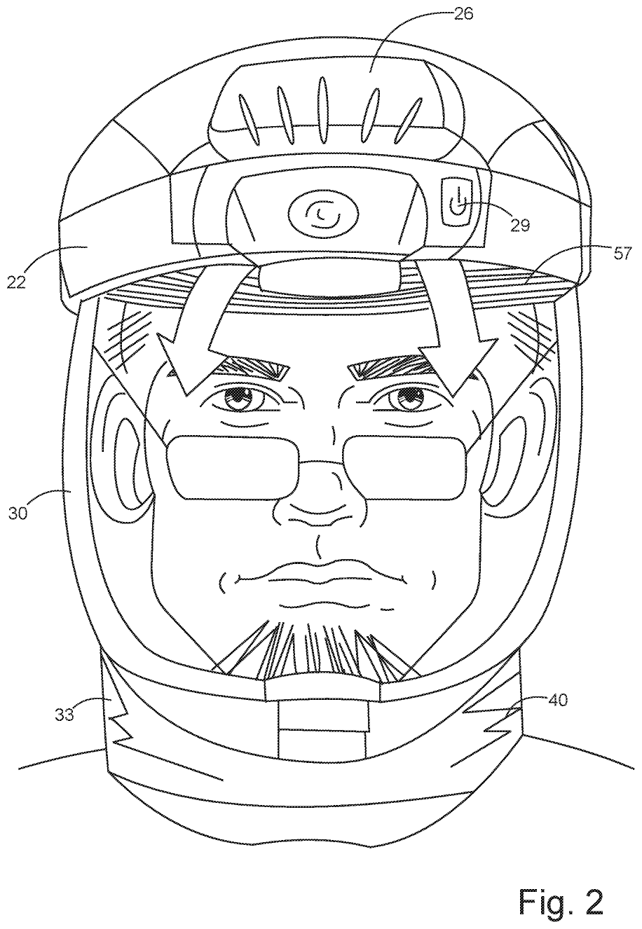

As seen in FIG. 2, the face cover 30 has a dome shape and can conform to the neck cover 40. A power button 29 can be mounted on the brim 21. The power button can control a light 27, or the fans. One or more fans can be used for intaking airflow and distributing airflow in the headcover 20. The battery housing 22 can be an elongated battery housing passing around a circumferential periphery of the headcover 20.

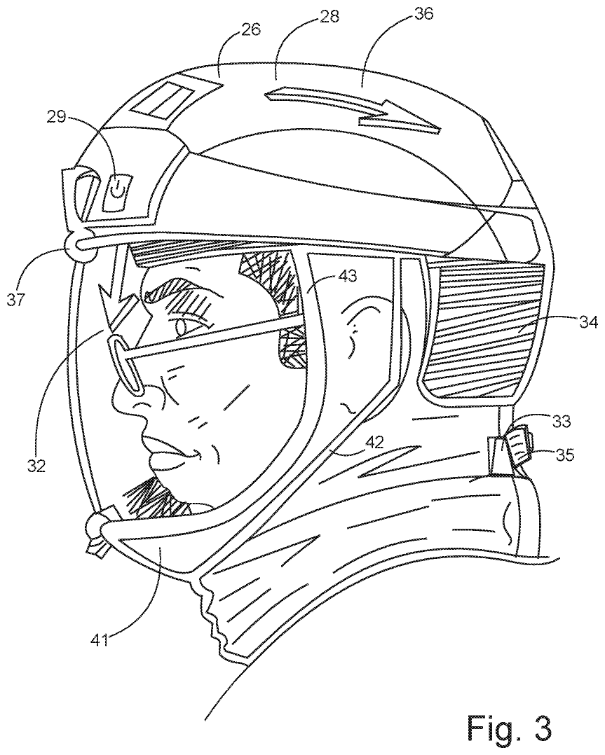

As seen in FIG. 3, preferably, a neck adapter 41 is semirigid and receives the face cover 30 at a face cover connection 43. The face cover connection 43 is curved for receiving the face cover 30. The neck adapter 41 is preferably also connected to the neck cover 40 at a neck adapter connection 42. The neck adapter 41 has an upper edge that connects to the headcover 20. The hook and loop flap connector 35 formed on the back of the neck cover 40 allows for circumference size adjustment. The neck cover 40 is preferably made of a moisture wick fabric 33. The neck adapter 41 is preferably a flexible sheet of plastic material and can be magnetically connected to the face cover 30 at the face cover connection 43. To enable the magnetic face cover connection 43, magnets can be mounted on the face cover 30 and the neck adapter 41. Additionally, a rear cushion 34 can be used for stability and comfort.

Behind the flip up cover hinge 28, the upper airflow 31 passes rearwardly over the top of a user's head. The upper airflow is separated from a lower airflow 32. The lower airflow 32 can pass downwardly and exit through fabric apertures in the moisture wick fabric 33. In this way, the face cover is slightly pressurized. The lower airflow and the upper airflow are preferably separated by a foam gasket that fills a space between the user's head and the headcover 20.

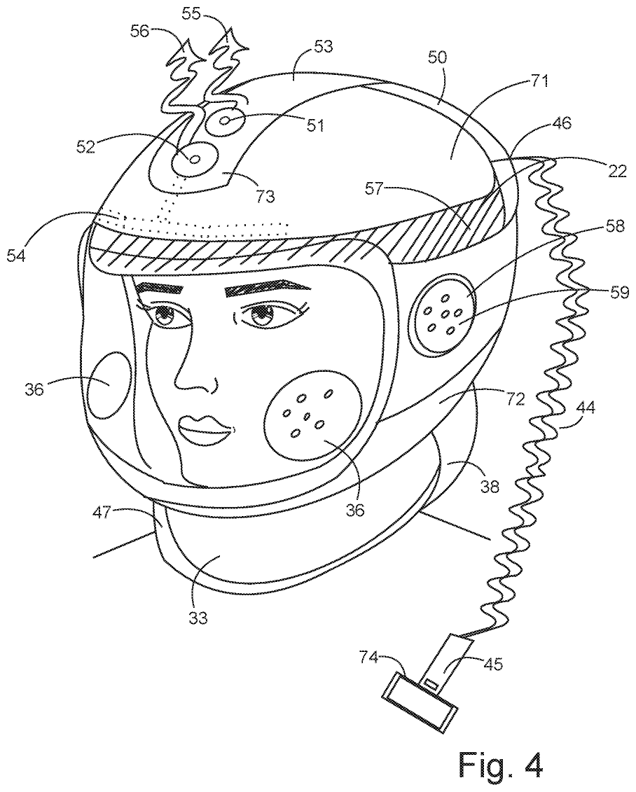

As seen in FIG. 4, the foam gasket forms a comfy headband 57. The headband separates the upper airflow 31 from the lower airflow 32. The comfy headband 7 can be mounted to a soft foam shell 50 which forms a shell of the headcover 20, A first airflow exhaust 55 and a second airflow exhaust 56 can be implemented by a first exhaust fan 51 and a second exhaust fan 52. The first exhaust fan is mounted higher into the rear of the second exhaust fan which is mounted forward and preferably lower. The second exhaust fan can circulate air for a thermoelectric cooler or a heat pipe 54 without a thermoelectric cooler 53. The heat pipe 54 can exhaust heat from the soft foam shell 50. The heat pipe 54 can extend downwardly to the lower section 72 for cooling the temples, ears or neck area of the user. The soft foam shell 50 preferably has variable rigidity with a softer rear portion and a harder portion around the airflow fans.

The thermoelectric cooler 53 is preferably reversible. The thermoelectric 53 is connected to the heat pipe 54, which is connected to the heat exchanger 73. When in a cooling mode, the thermoelectric cooler draws heat from the user to the heat pipe 54, which then carries the heat to that heat exchanger 73. The heat in the heat exchanger 73 is then exhausted away from the headcover 20 using the first or second fan. In a heating mode, the thermoelectric cooler 53 becomes a thermoelectric heater and the heat is transferred in reverse of the cooling mode.

In a first mode, the exhaust fans exhaust air out of the upper section 71 and the lower section 72 so that airflow passes from the rear of the head to the front of the head, and upwards from a lower portion of the face to an upper portion of the face. The air intake in the first mode occurs by drawing air through the face filters 36. The face filters 36 and the ear filters 59 can receive filtered air through them so that the ears and face stay cool. Ear openings 58 formed on the soft foam shell 50 can allow air and sound to aspirate. Similarly, the heat pipe 54 can warm a heat exchanger 73 that draws heat away from the user. To minimize heat generation in the headcover 20, the battery or a portion of the battery can be mounted away from the headcover 20 and electricity supply through a power cable 44. When using the power cable 44, a power plug 45 connects to an external battery 74. The external battery 74 can be used in conjunction with the battery housing 22. An electrical connector 46 can connect the external battery 74 to the battery housing 22, or to the controller that operates the fans. The neck wrap 47 can have a fabric cover 33 over the neck wrap 47, and the fabric cover 33 may have a neck cushion 38 to support a rear portion of the neck and head. The neck wrap 47 can have a bubble shape that adheres to the user to form a seal with the skin of the user when the exhaust fan is decreasing the pressure around the face cover 30. The neck wrap 47 is similarly configured to release from the user to release the seal when the exhaust fan increases the pressure around the face cover 30. The neck wrap 47 therefore has alternating release and adhesion. The neck wrap adhesion is not necessarily airtight, but greatly decreases airflow through the neck wrap 47.

The first mode is shown in FIG. 4 and the second mode is shown in FIGS. 1-3. The first mode provides a lower than ambient pressure in the lower section 72 and the upper section 71. The second mode provides a higher than ambient pressure in the lower section 72 and the upper section 71. The first exhaust fan 51 can alternate between intake of air and exhaust of air. The second exhaust fan 52 can alternate between intake of air and exhaust of air.

The headcover has an upper section 71 and a lower section 72 that are separated by a comfy headband 57. The face cover 30 is in the lower section 72 is preferably clear plastic polycarbonate sheet formed to conform to a curved profile. The neck cover 40 is also in the lower section 72 and is preferably made of a moisture wick fabric having elasticity and conforming to the neck of a wearer.

The mode can be alternated by selecting DC bidirectional motors and configuring them on H bridge control circuits, Preferably, a fan assembly 80 has a pair of bidirectional fan motors, namely a first fan motor 81, and a second fan motor 82 are configured in separate bidirectional H bridge control circuits 83 implemented on a circuit board held within the soft foam shell 50. The first motor has a first motor first mode signal 83 and a first motor second mode signal 84. The second motor has a second motor first mode signal 85 and a second motor second mode signal 86. The first motor has a first bidirectional H bridge control circuit 87 and the second motor has a second bidirectional H bridge control circuit 88. The first bidirectional H bridge control circuit 87 and the second bidirectional H bridge control circuit 88 are connected to a control module 90 with a controller such as an integrated circuit 95 and powered by a Vcc 12V 89 with a ground 94. The first motor control harness 91 and the second motor control harness 92 each have a pair of signal wires for controlling the motors.

A user can input a user mode selection 98 input to the controller 95 from a control such as a Bluetooth enabled mobile phone connection. The controller 95 can output a first seven segment display 96 and a second seven segment display 97 to show the user operational status on a display 100. The pair of seven segment displays can provide a double digit or double letter operational indicator. The power output control 99 can be used to control fan motor speed by decreasing voltage or by pulse width modulation of the nominal 12 V power supply line 89 that powers the first motor 81 and the second motor 82 also noted as Vcc 12V.

The modes of the fans can be sinusoidal, beginning first with exhaust, then intake, then exhaust. In this way, the user can adapt to different environmental considerations such as high humidity, heat or cold. The fans can also be controlled by a step function where both fans are on; one fan is in suction while the other one is opposed.

For example, the second exhaust fan 52 can be only connected to the lower section 72 and draw air through the face filter 36 and the ear filter 59 when a user is hot. Simultaneously, a first exhaust fan can intake air and be only connected to the upper section 71 to provide an airflow 31 to cool the top of the head. Thus, each individual fan can be operated either synchronously, or individually. It is preferred that the upper section 71 is only fluidly connected to the first exhaust fan 51. It is preferred that the lower section 72 only be connected to the second exhaust fan. A baffle can be formed between the lower section 72 and the upper section 71 to control airflow between the lower section 72 and the upper section 71.

A third bidirectional H bridge control circuit can control the thermoelectric cooler to allow both cooling and heating. The third bidirectional H bridge control circuit is also preferably connected to the controller which can be an IC chip. The user mode selection 98 can be Bluetooth enabled for user smartphone application selection of different fan and cooling modes, which are then displayed on the display 100 as a visual mode confirmation.

1. A powered air purifying respirator comprising:
a. a headcover, wherein the headcover has an air intake;
b. a face cover, wherein the face cover seals to the headcover and pivots from the headcover;
c. a neck cover, wherein the neck cover extends from the headcover and the face cover;
d. an first fan powered by a fan motor;
e. an upper section, wherein the first fan is flow connected to the upper section, wherein the upper section is formed as a hollow area between a user's head and the headcover;
f. a lower section, wherein the first fan is flow connected to the lower section, wherein the lower section is formed as a hollow area between a user's face and the face cover; and
g. a filter drawing air from outside of the upper section and lower section, wherein the filter is driven by the fan.

2. The powered air purifying respirator of claim 1, further including a second fan, wherein the second fan connects to the lower section, wherein the second fan is reversible.

3. The powered air purifying respirator of claim 1, further including a face filter mounted on the face cover, wherein the face filter is configured to filter incoming air.

4. The powered air purifying respirator of claim 1, further including an ear filter mounted on the headcover, wherein the ear filter is configured to filter incoming air.

5. The powered air purifying respirator of claim 1, further including a headband separating the section from the lower section.

6. The powered air purifying respirator of claim 1, wherein the headcover is made of a soft foam shell.

7. The powered air purifying respirator of claim 1, further including a neck wrap, wherein the neck wrap further includes a neck cushion.

8. The powered air purifying respirator of claim 1, further including a heatpipe mounted within the headcover for exhaustion from the upper section.

9. The powered air purifying respirator of claim 1, further including a brim that extends outwardly, wherein a light and a power switch are mounted on the brim.

10. The powered air purifying respirator of claim 1, further including internal airflow channels formed on the upper section, wherein the airflow channels direct air from a front of a user's head to a rear of a user's head.

11. The powered air purifying respirator of claim 1, further including a rear cushion mounted on the headcover.

12. The powered air purifying respirator of claim 1, wherein the headcover further includes a neck adapter, wherein the neck adapter connects to the face cover at a face adapter connection, wherein the face adapter connection is formed as a releasable gasket, wherein the neck adapter further includes a neck cover connection.

13. The powered air purifying respirator of claim 1, wherein the upper section has an upper airflow across a users head, and wherein the lower section retains a lower airflow across a user's face.

14. The powered air purifying respirator of claim 1, further including a second fan powered by a second fan motor, wherein the first fan motor and the second fan motor are reversible.

15. The powered air purifying respirator of claim 14, wherein the first fan motor is connected to a first bidirectional H bridge control circuit and wherein the second fan motor is connected to a second bidirectional H bridge control circuit.

16. The powered air purifying respirator of claim 15, further including a controller that controls the first bidirectional H bridge control circuit and the second bidirectional H bridge control circuit.

17. The powered air purifying respirator of claim 15, further including a display mounted to the headcover for displaying a visual indicator of an operating status of the powered air purifying respirator, wherein the display is connected to the controller.

18. The powered air purifying respirator of claim 17, further including a face filter mounted on the face cover, wherein the face filter is configured to filter incoming air, further including an ear filter mounted on the headcover, wherein the ear filter is configured to filter incoming air, wherein the headcover is made of a soft foam shell, further including a neck wrap, wherein the neck wrap further includes a neck cushion.

19. The powered air purifying respirator of claim 1, further including a battery mounted battery housing, wherein the battery housing to the headcover, further including a brim that extends outwardly, wherein a light and a power switch are mounted on the brim, further including internal airflow channels formed on the upper section, wherein the airflow channels direct air from a front of a user's head to a rear of a user's head, further including a rear cushion mounted on the headcover.

20. The powered air purifying respirator of claim 1, wherein the headcover further includes a neck adapter, wherein the neck adapter connects to the face cover at a face adapter connection, wherein the face adapter connection is formed as a releasable gasket, wherein the neck adapter further includes a neck cover connection, wherein the upper section has an upper airflow across a users head, and wherein the lower section retains a lower airflow across a user's face.
